(19) United States
(12) Patent Application Publication
(10) Pub. No.: US 2007/0042502 A1
(43) Pub. Date: Feb. 22, 2007

(54) Technology for the determination of impurities in TRODAT-1 raw material

(75) Inventors: Kung Tien Liu, Lungtan, Taoyuan (TW); Yi Chih Hsia, Lungtan, Taoyuan (TW); Chang Yung Su, Lungtan, Taoyuan (TW); Chiung Fang Huang, Lungtan, Taoyuan (TW); Ying Kai Fu, Lungtan, Taoyuan (TW)

Correspondence Address: MICHAEL LIN, 5F 79 Roosevelt Rd. Sec. 2, TAIPEI, 106, TW

(73) Assignee: INSTITUTE OF NUCLEAR ENERGY RESEARCH, Lungtan, Taoyuan (TW)

(21) Appl. No.: 11/161,888

(22) Filed: Aug. 21, 2005

(51) Int. Cl. G01N 30/02

(52) U.S. Cl. 436/177; 436/161

(57) ABSTRACT

This invention discloses a novel technology for the impurities assay of TRODAT-1 raw material by reverse phase high performance liquid chromatography (RP-HPLC). The method for TRODAT-1 raw material impurities assay of this present invention includes using high performance liquid chromatography (HPLC), liquid chromatography tandem mass spectrometry (LC-MS/MS), HPLC column, preparation of samples, regents and eluent as well as performing parent and product ion analysis by mass spectrometry for the method validation, calculation of chromatographic resolution and raw material impurities. This invention is the first report in the world that proved the existence of oligomers in TRODAT-1 raw material, as well as an analytical method through elaborated validation procedures to quantify the impurities (including the oligomers) in TRODAT-1 raw material.

### FIELD OF THE INVENTION

The present invention relates to an analytical technology developed by using the reverse phase high performance liquid chromatography (RP-HPLC) and liquid chromatography tandem mass spectrometry (LC-MS/MS). It is devised for method development and validation to identify the chemical structures and content of the impurities in raw material of TRODAT-1 (ethanethiol,2-[[2-[[[3-(4-chlorophenyl)-8-methyl-8-azabicyclo [3,2,1]oct-2-yl]methyl](2-mercaptoethyl)amino]ethyl]amino],[1R-(exo-exo)]-,hydrochloride).

### BACKGROUND OF THE INVENTION

Technetium-99m-TRODAT-1 is a diagnostic imaging agent specifically binding to dopamine transporter in the basal ganglia region of the brain. TRODAT-1 is the unlabelled precursor of ^{99m}Tc-TRODAT-1. At present, extensively using TRODAT-1 raw material for research and development are mainly focus in the laboratories such as: Hospital of the University of Pennsylvania, USA (J. Nucl. Med. 2000 April; 41 (4) 584-9), Institute of Nuclear Energy Research, Taiwan (J. Nucl. Med. 2001 March; 42 (3) 408-13), National Laboratory of Nuclear Medicine, China (Nucl. Med. Biol. 2000 January; 27 (1) 69-75), Leuven University Hospital and Katholieke Universiteit Leuven, Belgium (Eur. J. Nucl. Med. Mol. Imaging. 2004 August; 31 (8) 1119-27), University of Munich, Germany (Eur. J. Nucl. Med. 2000 October; 27 (10) 1518-24), and Institute of Syncor Corporation (J Zhejiang Univ Sci. 2005 January; 6 (1) 22-7). However, in all literatures published already, reports related to evaluation of TRODAT-1 raw material purity and impurities have not yet become available. Moreover, up to the present, no official purity assay method is specified in the United States Pharmacopeia (USP), European Pharmacopoeia (EP), and British Pharmacopoeia (BP). Therefore, proposal of this method is the first invention in the world that has completed the validation procedures for the impurities assay of TRODAT-1 raw material.

### SUMMARY OF THE INVENTION

This invention is the first report in the world to determine the impurities and to prove the existence of oligomers in TRODAT-1 raw material by LC-MS/MS, as well as an analytical technology of quantification of the impurities by RP-HPLC.

The methodologies for the determination of impurities in TRODAT-1 raw material include instrumental facilities, reagents, sample preparations, chromatographic conditions, and calculation formulae. They are elaborated respectively as below:

(1) Instrumentation and Reagents

a. The high performance liquid chromatography (HPLC) consisted of a HPLC pump, a vacuum degasser, an injector, an autosampler, a thermostated column compartment, and a variable wavelength detector (VWD) or a photo-diode array detector (DAD).

b. Liquid chromatography—tandem mass spectrometer (LC-MS/MS).

c. HPLC C-18 reversed phase column.

d. Methanol (MeOH) and trifluoroacetic acid (TFA).

(2) Preparation of Standards, Samples and Eluent:

a. Preparation of standards and samples for HPLC: All standards and samples were prepared in HPLC exclusive sample vial, by dissolving 4-5 mg of TRODAT-1 in 1 mL of HPLC grade methanol.

b. Preparation of HPLC eluent [0.1% TFA/MeOH—H₂O (50:50, v/v)]: 500 mL of HPLC grade MeOH was mixed evenly with 500 mL of deionized water, 1 mL of TFA was then added.

c. Preparation of standards and samples for MS: All standards and samples were prepared in HPLC exclusive sample vial, by dissolving 4-5 mg of TRODAT-1 in 1 mL of HPLC grade methanol, and dilution of the samples with methanol to 100˜1000 times.

(3) The HPLC Conditions:

Column: C-18 reversed phase column

Eluent: 0.1% TFA/MeOH—H₂O (50:50, v/v)

Flow rate: 0.5 mL/min

Column temperature: 25° C.

Wavelength of UV detection: 210 nm

(4) The Analysis Conditions of LC-MS/MS

Ion Source: Turbo ion spray

Polarity: Positive ion mode

Scan Mode: Profile scan

Scan type: Q3 MS and Product Ion, MS2

Ion scan range: 50-950

(5) Resolution of chromatogram
R=[(t_{R2}−t_{R1})/(W_{half2}+W_{half1})]×1.18

t_{R2} and t_{R1} are the respective retention time of the two neighboring peaks;

W_{half2} and W_{half1} are the respective half height width of the two neighboring peaks

### BRIEF DESCRIPTION OF THE DRAWINGS

FIG. 1 illustrates HPLC chromatogram of TRODAT-1 raw material.

FIG. 2 illustrates (a) Parent ion mass spectrum and (b) product ion mass spectrum of TRODAT-1.

FIG. 3 illustrates mass spectra of the impurities in TRODAT-1 raw material, correspond to the retention time of the peaks on HPLC chromatogram at (a) 3.7 min, (b) 4.2 min, (c) 5.2 min, (d) 14.6 min, (e) 16.5 min and (f) 19.0 min, respectively.

FIG. 4 illustrates mass spectra of product ions of impurities in TRODAT-1 raw material, corresponds to the m/z of the impurities of (a) 500 amu, (b) 685 amu and (c) 853 amu, respectively.

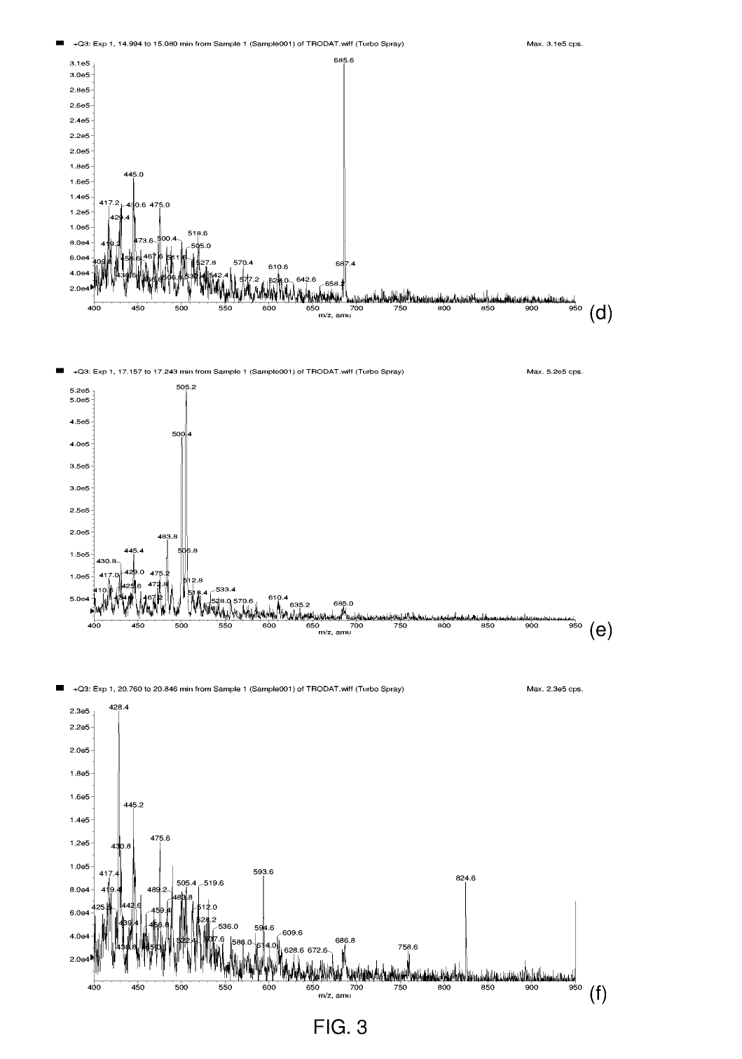

FIG. 5 illustrates proposed chemical structures and molecular weights of the parent and product of TRODAT-1 in the mass spectra: (a) molecular formula =C₂₁H₃₄ClN₃S₂, molecular weight =428.10; (b) molecular formula =C₁₅H₂₀ClN, molecular weight =249.78.

FIG. 6 illustrates proposed chemical structure of the possible existence dimer of TRODAT-1 in the raw material.

### DETAILED DESCRIPTION OF PREFERRED EMBODIMENTS

### Example

### HPLC Analysis and LC-MS/MS Method Validation

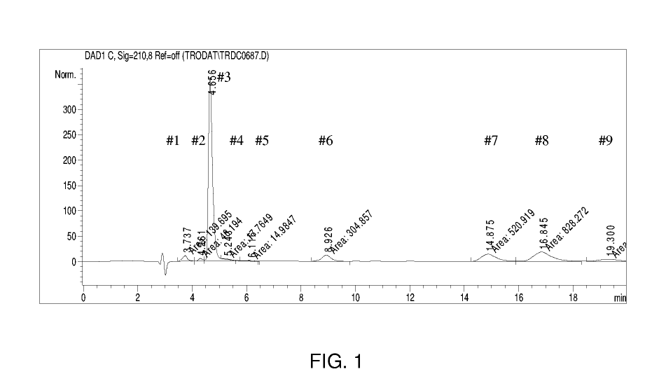

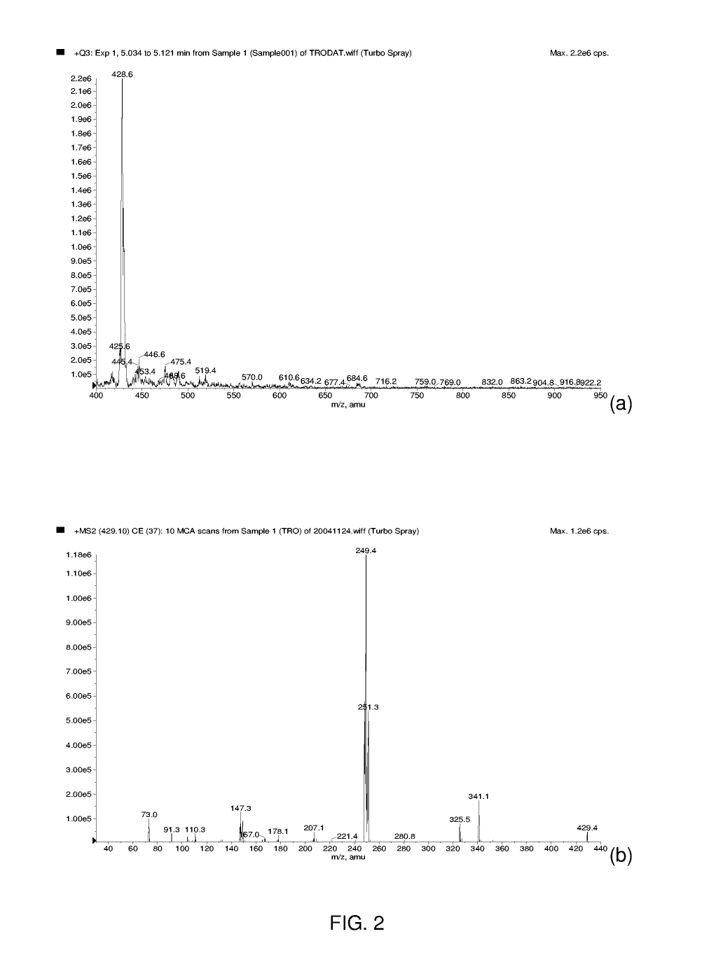

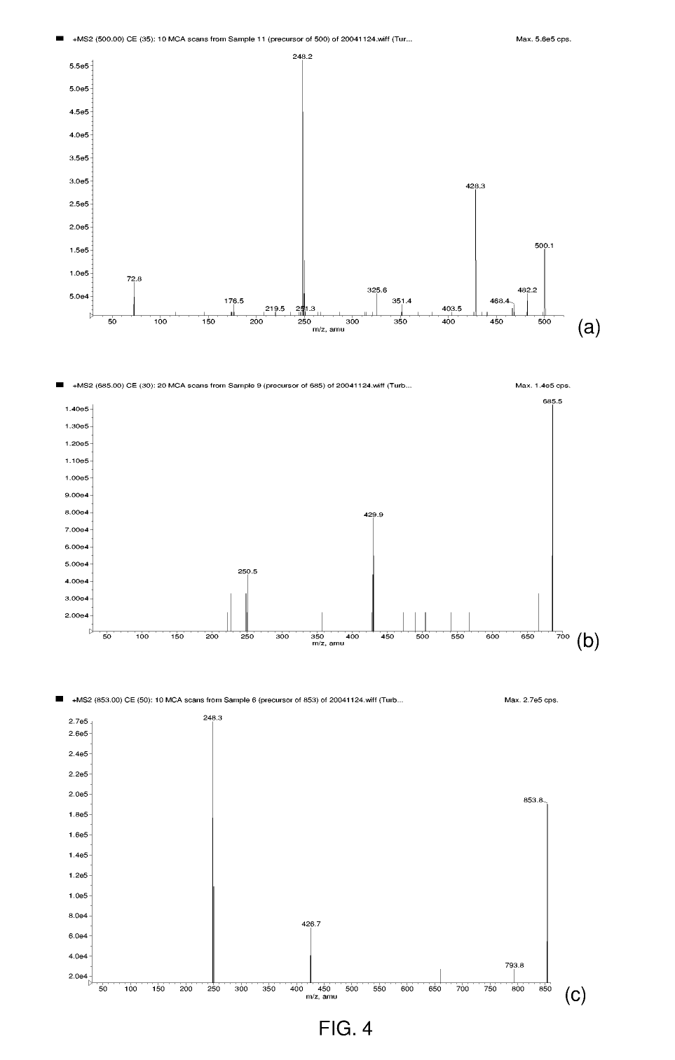

HPLC results were shown in FIG. 1 and Table 1, the nine peaks on the chromatogram were numbered with peak #1˜peak #9. Parent ion (m/z=428) and product ion analysis (m/z=249) were achieved by liquid chromatography tandem mass spectrometry (LC-MS/MS), and the results were summarized in FIG. 2 and Table 2. FIG. 2 displayed the mass spectra of parent ion scan (a) and product ion scan (b) of the major component of TRODAT-1. It was confirmed that peak #3, whose retention time is 4.610±0.048 min, was TRODAT-1 and the purity of the sample was 65.05±1.53%. FIG. 5 illustrated the proposed chemical structures and molecular weights of the products achieved by the parent ion and product ion mass spectra of TRODAT-1, the molecular formulae and molecular weights are: (a) molecular formula=C₂₁H₃₄ClN₃S₂, molecular weight =428.10; (b) molecular formula=C₁₅H₂₀ClN, molecular weight =249.78.

TABLE 1
HPLC results for TRODAT-1 raw material

| | | Correlation | |
|---|---|---|---|
| Peak no. | Retention time (min)^{a} | coefficient^{b} | Peak area % |
| #1 | 3.694 ± 0.053 | 1.0000 | 2.27 ± 0.13% |
| #2 | 4.246 ± 0.011 | 1.0000 | 0.54 ± 0.41% |
| #3 | 4.610 ± 0.048 | 1.0000 | 65.05 ± 1.53% |
| #4 | 5.228 ± 0.015 | 1.0000 | 0.24 ± 0.18% |
| #5 | 6.076 ± 0.056 | 0.8556 | 0.26 ± 0.11% |
| #6 | 8.843 ± 0.094 | 0.9968 | 5.03 ± 0.39% |
| #7 | 14.641 ± 0.289 | 0.9998 | 8.97 ± 0.38% |
| #8 | 16.535 ± 0.362 | 0.9992 | 13.29 ± 0.54% |
| #9 | 19.018 ± 0.363 | 0.9919 | 4.36 ± 0.51% |

^{a}Average retention time for n = 9
^{b}Correlation curves in the injection volume range of 1˜5 μL, n = 3

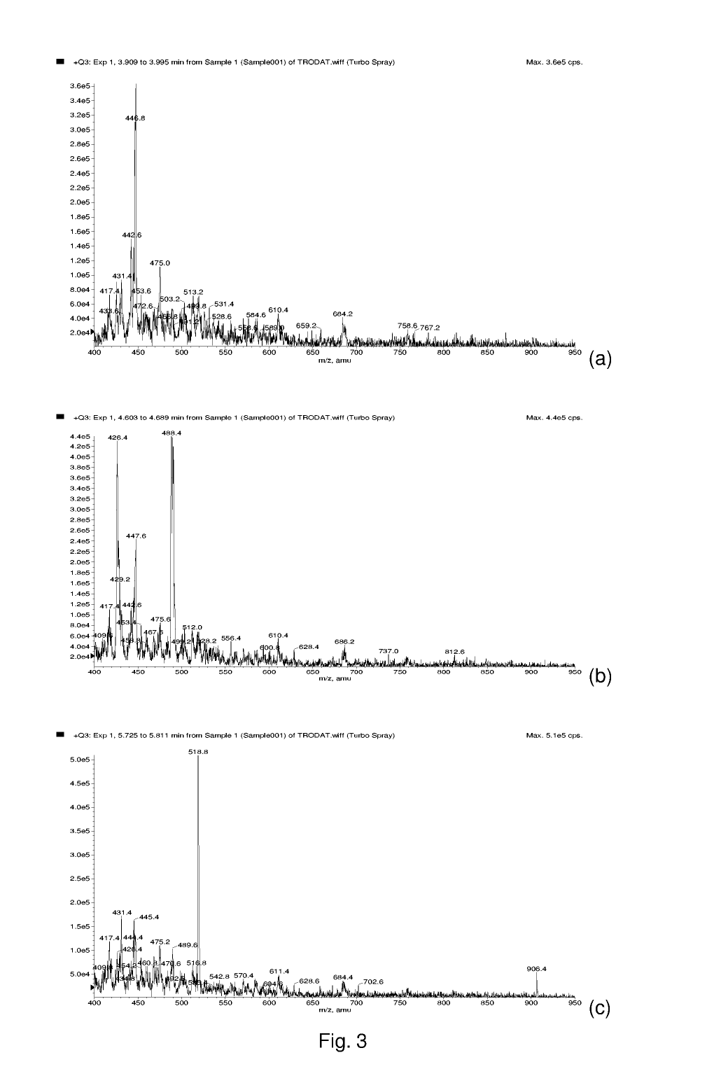

TABLE 2
HPLC-MS/MS results for TRODAT-1 raw material

| | Retention time in | | MS with m/z | |
|---|---|---|---|---|
| Peak no. | HPLC (min) | m/z | of 426-430 | MS spectra |
| #1 | 3.694 ± 0.053 | 446.8 | No | FIG. 3.a |
| #2 | 4.246 ± 0.011 | 488.4 | Yes | FIG. 3.b |
| #3 | 4.610 ± 0.048 | 428.6 | Yes | FIG. 2.a |
| #4 | 5.228 ± 0.015 | 518.8 | No | FIG. 3.c |
| #5 | 6.076 ± 0.056 | — | No | — |
| #6 | 8.843 ± 0.094 | <400 | — | — |
| #7 | 14.641 ± 0.289 | 685.6 | Yes | FIG. 3.d |
| #8 | 16.535 ± 0.362 | 505.2 | Yes | FIG. 3.e |
| #9 | 19.018 ± 0.363 | 824.6 | Yes | FIG. 3.f |

The product ions mass spectra (Q3 and MS2) of peak #2, peak #7, peak #8 and peak #9 all contained a large number of m/z=426-430, 248-250 ions (as shown in FIGS. 3˜4). FIG. 3 displayed the mass spectra of the impurities in TRODAT-1 raw material, the retention time of the impurities on the HPLC chromatogram corresponded to (a) 3.7 min, (b) 4.2 min, (c) 5.2 min, (d) 14.6 min, (e) 16.5 min and (f) 19.0 min, respectively. Table 2 is the summary of the results.

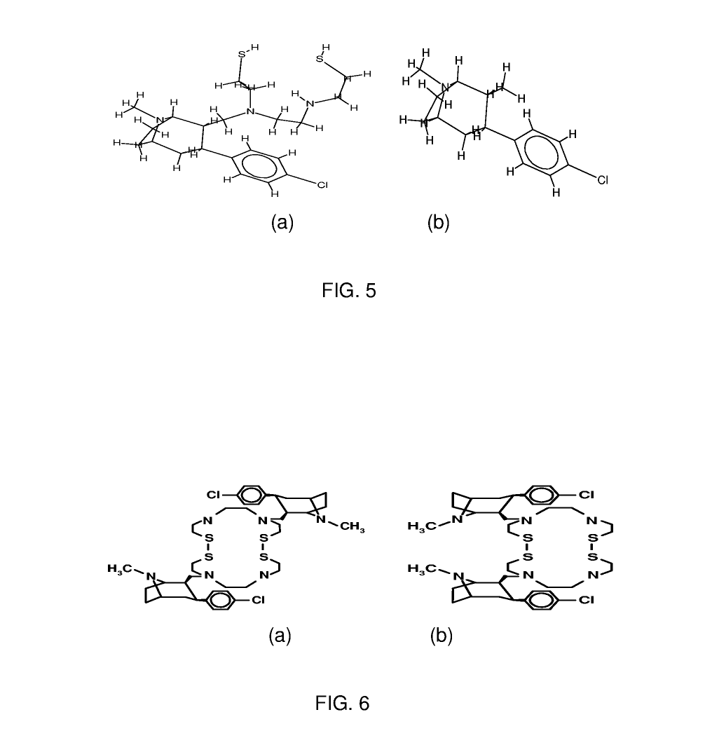

First of all, it indicated that the structures of these compositions were the same as that of TRODAT-1; besides, the m/z value of the peak at retention time 19 minutes was 824.6 (accounted for 4.36% of content), which was very close to 852.18, the molecular weight of the dimer of TRODAT-1. In addition, according to the precursor ion MS experiment, it was confirmed the major source of m/z 249 was 430 amu, i.e., TRODAT-1. Therefore, it is presumed that the compositions of peak #2, peak #7, peak #8, peak #9 are very likely from the derivatives of TRODAT-1 or the results from partial degradations of the oligomer (dimer or trimer) of TRODAT-1 formed in the raw material, these composed 27.16% of the total content. It is also hypothesized that dimers of the TRODAT-1 may be existed in two forms (type I and type II) in the raw material, the suggested chemical structures are depicted in FIG. 6. With the molecular formula=C₄₂H₆₄Cl₂N₆S₄ and molecular weight=852.18, the proposed two dimer forms of TRODAT-1 are as follow:

(TRODAT-1)₂ Type I (abbreviated as 1-drT/ [symbol] [symbol] /Trd-1);

(TRODAT-1)₂ Type II (abbreviated as Trd-1/ [symbol] [symbol] /Trd-1).

Further verification by addition of NaOH for forced degradation testing indicated that the absorption of peak #3 (TRODAT-1), peak #8 and peak #9 reduced with time increased. Peak #2 and peak #6 formed after TRODAT-1 being degraded, and were accounted for 5.57% of the total content. As to peak #1, peak #4 and peak #5, the possible compositions are still unknown, but no relation with TRODAT-1, and the total content of these 3 peaks was 2.77%.

The examples described here are the better examples to describe this present invention, an analytical method for the impurities assay of TRODAT-1 raw material. For those who have already familiar with this skill can still consult the explanation of this invention, make modification or change and get the same results. The modification and change should still be within the scope of this invention. The invention should not be interpreted as confined to the specific form and examples as displayed and described; instead it is set forth to the following claims.

What is claimed is:

1. An assay method for the impurities assay of TRODAT-1 raw material includes utilization high performance liquid chromatography (HPLC), liquid chromatography tandem mass spectrometry (LC-MS/MS), HPLC column, preparation of samples, regents and eluent as well as method validation of performing parent ion and product ion analysis by mass spectrometry, calculation of chromatographic resolutions and quantification of raw material impurities, wherein:
The HPLC consisted of a pump, a degasser, an injector, an autosampler, a thermostated column compartment, and a variable wavelength detector (VWD) or a photo-diode array detector (DAD);
The HPLC conditions are as follows:
Column: C-18 reverse phase column
Eluent: 0.1% TFA/MeOH—H₂O (50:50, v/v)
Flow rate: 0.5 mL/min
Column temperature: 25° C.
Wavelength of UV detection: 210 nm
Reagents: methanol and trifluoroacetic acid (TFA);
Preparation of the standard and sample solutions: TRODAT-1 was dissolved in methanol to an appropriate concentration;
Preparation of eluent: TFA was added to the mixture of methanol and de-ionized water;
Calculation of HPLC resolution
R=[(t_{R2}−t_{R1})/(W_{half2}+W_{half1})]×1.18
t_{R2} and t_{R1} are the respective retention time of the two neighboring peaks;
w_{half2} and w_{half1} are the respective half height width of the two neighboring peaks.

2. The assay method as 1, wherein the TRODAT-1 raw materials include TRODAT-1 and relevant derivatives of tropane.

3. The assay method as claim 1, wherein the impurities in TRODAT-1 raw material can be qualitative and quantitative analyzed include the oligomer (dimer or trimer) of TRODAT-1 and their partial degradations; also include the partial degradants directly from TRODAT-1.

4. The assay method as claim 1, wherein the HPLC column includes various reverse phase columns and do not subjected to the C-18 column this invention specified.

5. The assay method as claim 1, wherein the TFA concentration of eluent is in the range of 0.1% to 0.5% in dissolution of MeOH—H₂O mixture from ratio of 40:60 to 60:40 (v/v).

6. The assay method as claim 1, wherein the flow rate of eluent is in the range of 0.5˜1.0 mL/min.

7. The assay method as claim 1, wherein the wavelength of UV detection is in the range of 210 nm ˜250 nm.
